(19) United States
(12) Patent Application Publication
(10) Pub. No.: US 2013/0275223 A1
(43) Pub. Date: Oct. 17, 2013

(54) FUTURE AD TARGETING

(71) Applicants: Jonathan Brelig, San Francisco, CA (US); Alexandre Linares, Mountain View, CA (US); Steven McClelland, San Francisco, CA (US); Sarah Jean Sosiak, San Francisco, CA (US)

(72) Inventors: Jonathan Brelig, San Francisco, CA (US); Alexandre Linares, Mountain View, CA (US); Steven McClelland, San Francisco, CA (US); Sarah Jean Sosiak, San Francisco, CA (US)

(73) Assignee: YAHOO! INC., Sunnyvale, CA (US)

(21) Appl. No.: 13/449,128

(22) Filed: Apr. 17, 2012

(51) Int. Cl. G06Q 30/02

(52) U.S. Cl. 705/14.61

(57) ABSTRACT

In one embodiment, the system obtains data from a plurality of user profiles associated with a plurality of users, where the data indicates one or more of a plurality of features pertaining to each of the plurality of users. The system predicts an action that a particular one of the plurality of users has or will have a high probability of intent, desire, or need to perform at a future time based, at least in part, upon the data that has been obtained from the plurality of user profiles. The system provides an advertisement or offer to the particular user based, at least in part, upon the action that the particular user has a high probability of intent, desire, or need to perform at a future time.

### BACKGROUND

The disclosed embodiments relate generally to methods and apparatus for providing offers or advertisements to users based, at least in part, upon predicted future intent, desire, or need to perform a particular action.

Advertisers typically pay online publishers to place their ads on a web page. In a popular pricing model, an advertiser is charged based upon the number of impressions that are delivered. Other pricing models may also be used. For example, in the pay-per-click mode, each advertiser is typically charged only when her ad receives a click.

Advertisers generally request that a minimum number of impressions (i.e., views) be guaranteed. In addition, advertisers may also specify additional conditions that are to be satisfied by the online publisher of the ads. For example, the advertisers may specify a desired target profile of users who are to receive a particular advertisement. As another example, advertisers may also specify a particular position in which an advertisement is to be placed on a web page. A publisher will therefore typically attempt to maximize their profits (e.g., by achieving high click-through-rates), while satisfying the requirements of the advertisers. Unfortunately, selecting advertisements to be provided to users while satisfying the requirements of advertisers is a complex process.

### SUMMARY

The disclosed embodiments enable user intent, desire, or need to perform particular action(s) in the future to be predicted. This may be accomplished based, at least in part, upon user profiles. Advertisements or offers pertaining to the action(s) may then be provided to user(s) based, at least in part, upon the predicted intent, desire, or need for the user(s) to perform the action(s).

In one embodiment, the system may obtain data from a plurality of user profiles associated with a plurality of users, where the data indicates one or more of a plurality of features pertaining to each of the plurality of users. The system may predict an action that a particular one of the plurality of users has or will have a high probability of intent, desire, or need to perform at a future time based, at least in part, upon the data that has been obtained from the plurality of user profiles. The system may provide an advertisement or offer to the particular user based, at least in part, upon the action that the particular user has a high probability of intent, desire, or need to perform at a future time.

In another embodiment, the system may obtain data from a plurality of user profiles associated with a plurality of users, the data indicating one or more of a plurality of features pertaining to each of the plurality of users. The system may identify one or more of the plurality of users that each have or will have a high probability of intent, desire, or need to perform a particular action at a future time based, at least in part, upon the data that has been obtained from the plurality of user profiles. The system may provide an advertisement or offer to the one or more of the plurality of users based, at least in part, upon the action that the one or more of the plurality of users have a high probability of intent, desire, or need to perform at a future time.

In another embodiment, the disclosed embodiments pertain to a device comprising a processor, memory, and a display. The processor and memory are configured to perform one or more of the above described method operations. In another embodiment, the disclosed embodiments pertain to a computer readable storage medium having computer program instructions stored thereon that are arranged to perform one or more of the above described method operations.

These and other features and advantages of the disclosed embodiments will be presented in further detail in the following specification and the accompanying figures which illustrate by way of example the disclosed embodiments.

### BRIEF DESCRIPTION OF THE DRAWINGS

FIG. 1 is a diagram illustrating an example system in which various embodiments may be implemented.

FIG. 2 is a process flow diagram illustrating an example method of providing an offer or advertisement to a particular user in accordance with various embodiments.

FIG. 3 is a process flow diagram illustrating an example method of providing offer(s) or advertisement(s) to one or more users in accordance with various embodiments.

FIG. 4 is a schematic diagram illustrating an example embodiment of a network in which various embodiments may be implemented.

FIG. 5 is a schematic diagram illustrating an example client device in which various embodiments may be implemented.

FIG. 6 is a schematic diagram illustrating an example computer system in which various embodiments may be implemented.

### DETAILED DESCRIPTION OF THE SPECIFIC EMBODIMENTS

Reference will now be made in detail to specific embodiments. Examples of these embodiments are illustrated in the accompanying drawings. These examples are being provided solely to add context and aid in the understanding of the present disclosure. It will thus be apparent to one skilled in the art that the techniques described herein may be practiced without some or all of these specific details. In other instances, well known process steps have not been described in detail in order to avoid unnecessarily obscuring the present disclosure. Other applications are possible, such that the following examples should not be taken as definitive or limiting either in scope or setting.

In the following detailed description, references are made to the accompanying drawings, which form a part of the description and in which are shown, by way of illustration, specific embodiments. Although these embodiments are described in sufficient detail to enable one skilled in the art to practice the disclosure, it is understood that these examples are not limiting, such that other embodiments may be used and changes may be made without departing from the spirit and scope of the disclosure.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Geo-targeting is typically used to select, create, transmit, and/or otherwise provide advertisements to website users based upon their current location and user profile features. The current location of website users may be determined based upon location data that the users have explicitly and/or implicitly provided to the website. More particularly, the location data may be obtained from account data provided by the users during registration or as a result of updating the account data after registration has been completed. For example, the account data may include a registration zip code, home location (e.g., address or portion thereof), and/or work location (e.g., address or portion thereof). Therefore, the account data for a particular website user may identify one or more locations of the website user. The current location of the website user may also be identified based upon signals explicitly transmitted by the user or implicit signals. Examples of implicit signals include an IP address of the website user, wifi triangulation, or Global Positioning System (GPS) location, which may be used to infer a current location, a home location, or a work location. As another example, the user's location may be implied through cell tower triangulation. A user may explicitly check in to a location via the use of a check in application, which may be accessed via a website and/or installed on a device such as a mobile device.

Geo-targeting typically focuses on location data explicitly or implicitly indicating the current location of the user. The assumption is that the user will likely take shopping action near the Normal Geographic Areas where the user spends the majority of their time. Normal Geographic Areas may include the user's home, work, school, etc. Geo-targeting may also consider user behavior outside their Normal Geographic Area (NGA). Areas outside of the NGA may include a parent's home, vacation locations, business travel, etc.

While the user's current location and the user's current profile features may be valuable for purposes of transmitting advertisements that might interest the user at the present time, the user's current location and current profile features may provide little insight into the actions that the user might take in the future. As a result, it is generally difficult to identify advertisements or offers that might appeal to the user based upon the user's future needs or desires.

Example System

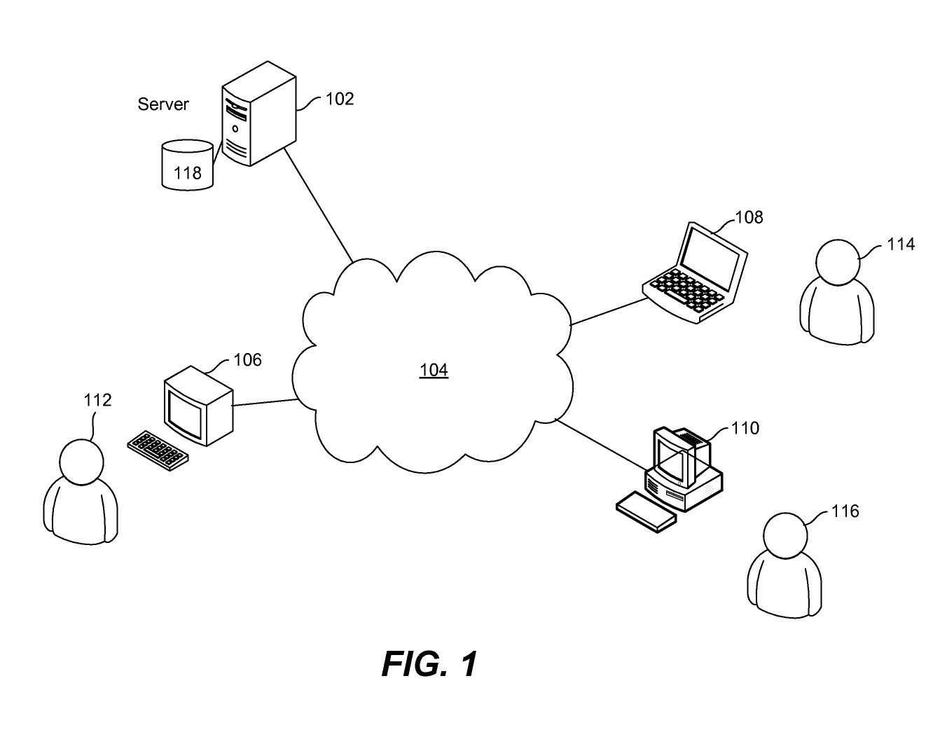

FIG. 1 is a diagram illustrating an example system in which various embodiments may be implemented. As shown in FIG. 1, the system may include one or more servers 102 associated with a web site such as a social networking web site. Examples of social networking web sites include Yahoo, Facebook, Tumblr, LinkedIn, Flickr, and Meme. The server(s) 102 may enable the web site to provide a variety of services to its users. More particularly, users of the web site may maintain public user profiles, interact with other members of the web site, upload files (e.g., photographs, videos), etc.

In this example, the server(s) 102 may obtain or otherwise receive data (e.g., account data and/or user profile) and/or requests (e.g., search requests) via the Internet 104 from one or more computers 106, 108, 110 in association with corresponding entities 112, 114, 116, respectively. For example, each of the entities 112, 114, 116 may be an individual, a group of individuals (e.g., group, business or company), or other entity such as a web site. However, in order to simplify the description, the disclosed embodiments will be described with reference to individuals that are users of the web site.

The server(s) 102 may have access to one or more user logs 118 (e.g., user databases) into which user information is retained for each of a plurality of users. This user information or a portion thereof may be referred to as a user profile. More particularly, the user profile may include public information that is available in a public profile and/or private information. The user logs 118 may be retained in one or more memories that are coupled to the server 102.

The user information retained in the user logs 118 may indicate a plurality of features for each user. More particularly, the features may include personal information such as demographic information (e.g., age and/or gender) and/or geographic information (e.g., residence address, work address, zip code, area code, and/or neighborhood urbanization level). In addition, each time a user performs online activities such as clicking on an advertisement or purchasing goods or services, information regarding such activity or activities may be retained as user data in the user logs 118. For instance, the user data that is retained in the user logs 118 may indicate the identity of web sites visited, identity of ads that have been selected (e.g., clicked on) and/or a timestamp. Therefore, features may indicate a purchase history with respect to one or more products, one or more types of products, one or more services, and/or one or more types of services. Additional features may indicate a marital status of the user, a number of children, an age of one or more children, and/or one or more interests of the user. Moreover, where the online publisher supports a search engine (e.g., via the server 102 or a separate search server), information associated with a search query, such as search term(s) of the search query, information indicating characteristics of search results that have been selected (e.g., clicked on) by the user, and/or associated timestamp may also be retained in the user logs 118. A user may be identified in the user logs 118 by a user ID (e.g., user account ID), information in a user cookie, etc.

In one embodiment, as an individual interacts with a software application, e.g., an instant messenger or electronic mail application, descriptive content, such in the form of signals or stored physical states within memory, such as, for example, an email address, instant messenger identifier, phone number, postal address, message content, date, time, etc., may be identified. Descriptive content may be stored, typically along with contextual content. For example, how a phone number came to be identified (e.g., it was contained in a communication received from another via an instant messenger application) may be stored as contextual content associated with the phone number. Contextual content, therefore, may identify circumstances surrounding receipt of a phone number (e.g., date or time the phone number was received) and may be associated with descriptive content. Contextual content, may, for example, be used to subsequently search for associated descriptive content. For example, a search for phone numbers received from specific individuals, received via an instant messenger application or at a given date or time, may be initiated.

Content within a repository of media or multimedia, for example, may be annotated. Examples of content may include text, images, audio, video, or the like, which may be processed in the form of physical signals, such as electrical signals, for example, or may be stored in memory, as physical states, for example. Content may be contained within an object, such as a Web object, Web page, Web site, electronic document, or the like. An item in a collection of content may be referred to as an “item of content” or a “content item,” and may be retrieved from a “Web of Objects” comprising objects made up of a variety of types of content. The term “annotation,” as used herein, refers to descriptive or contextual content related to a content item, for example, collected from an individual, such as a user, and stored in association with the individual or the content item. Annotations may include various fields of descriptive content, such as a rating of a document, a list of keywords identifying topics of a document, etc.

A profile builder may initiate generation of a profile, such for users of an application, including a search engine, for example. A profile builder may initiate generation of a user profile for use, for example, by a user, as well as by an entity that may have provided the application. For example, a profile builder may enhance relevance determinations and thereby assist in indexing, searching or ranking search results. Therefore, a search engine provider may employ a profile builder, for example.

A variety of mechanisms may be implemented to generate a profile including, but not limited to, collecting or mining navigation history, stored documents, tags, or annotations, to provide a few examples. A profile builder may store a generated profile. Profiles of users of a search engine, for example, may give a search engine provider a mechanism to retrieve annotations, tags, stored pages, navigation history, or the like, which may be useful for making relevance determinations of search results, such as with respect to a particular user.

An online publisher (i.e., web publisher) will generally be responsible for delivering multiple advertisements and/or offers via the Internet (or other communication media such as email, text message, or digital television). A contract agreement associated with a particular advertisement (or offer) may specify a minimum number of page views (i.e., impressions) to be delivered within a particular period of time. The web publisher is therefore responsible for providing the requested number of impressions for each advertisement (or offer).

In accordance with various embodiments, the system may store a plurality of advertisements and/or offers. Each of the advertisements and/or offers may be associated with a target number of impressions and/or a target profile indicating one or more features of the individuals that are to receive the impressions. An online publisher may agree to provide offers and/or advertisements to users in accordance with the specified target profile and number of impressions in accordance with disclosed embodiments, as will be described in further detail below.

An advertisement or offer may include content pertaining to a product or service, which may be delivered via the Internet, email, text message, or digital television. The content typically includes text. However, it is important to note that an advertisement or offer may include text, one or more images, video, and/or audio. An advertisement or offer may also include one or more hypertext links, enabling a user to proceed with the purchase of a particular product or service.

The disclosed embodiments enable offers and/or advertisements associated therewith to be identified, selected, generated, transmitted, and/or otherwise provided to users in accordance with the disclosed embodiments. More particularly, the server(s) 102 may provide offers and/or advertisements associated therewith to the users via the web site (e.g., via display on a web page of the web site), via electronic mail, Short Message Service (SMS), via a mobile device (e.g., text message), or via another medium such as digital television, which may be connected to the Internet.

Where an offer or advertisement associated therewith is provided to a particular user, information pertaining to the offer or advertisement (e.g., identifying a product or service) may be stored in association with the user's account data. For example, information identifying an offer, advertisement, or product/service identified in the offer/advertisement may be stored in association with the user's account data. In addition, the server(s) 102 may automatically collect online (and/or real world) behavioral data for any of users 112, 114, 116 to determine whether the advertisement or offer was successful. In other words, the server(s) 102 may determine whether the user purchased the product or service advertised in the advertisement or offer. For example, the server(s) 102 may determine whether a product or service is subsequently downloaded or purchased. Data indicating whether the advertisement or offer was successful (e.g., whether the product or service is accessed or purchased) may be stored in association with the user's account data and/or the advertisement/offer.

Advertising

Various monetization techniques or models may be used in connection with sponsored search advertising, including advertising associated with user search queries, or non-sponsored search advertising, including graphical or display advertising. In an auction-type online advertising marketplace, advertisers may bid in connection with placement of advertisements, although other factors may also be included in determining advertisement selection or ranking Bids may be associated with amounts advertisers pay for certain specified occurrences, such as for placed or clicked-on advertisements, for example. Advertiser payment for online advertising may be divided between parties including one or more publishers or publisher networks, one or more marketplace facilitators or providers, or potentially among other parties.

Some models may include guaranteed delivery advertising, in which advertisers may pay based at least in part on an agreement guaranteeing or providing some measure of assurance that the advertiser will receive a certain agreed upon amount of suitable advertising, or non-guaranteed delivery advertising, which may include individual serving opportunities or spot market(s), for example. In various models, advertisers may pay based at least in part on any of various metrics associated with advertisement delivery or performance, or associated with measurement or approximation of particular advertiser goal(s). For example, models may include, among other things, payment based at least in part on cost per impression or number of impressions, cost per click or number of clicks, cost per action for some specified action(s), cost per conversion or purchase, or cost based at least in part on some combination of metrics, which may include online or offline metrics, for example.

Ad Networks/Exchanges

A process of buying or selling online advertisements may involve a number of different entities, including advertisers, publishers, agencies, networks, or developers. To simplify this process, organization systems called “ad exchanges” may associate advertisers or publishers, such as via a platform to facilitate buying or selling of online advertisement inventory from multiple ad networks. “Ad networks” refers to aggregation of ad space supply from publishers, such as for provision en masse to advertisers.

Ad Targeting

For web portals like Yahoo!, advertisements may be displayed on web pages resulting from a user-defined search based at least in part upon one or more search terms. Advertising may be beneficial to users, advertisers or web portals if displayed advertisements are relevant to interests of one or more users. Thus, a variety of techniques have been developed to infer user interest, user intent or to subsequently target relevant advertising to users.

One approach to presenting targeted advertisements includes employing demographic characteristics (e.g., age, income, sex, occupation, etc.) for predicting user behavior, such as by group. Advertisements may be presented to users in a targeted audience based at least in part upon predicted user behavior(s).

Another approach includes profile-type ad targeting. In this approach, user profiles specific to a user may be generated to model user behavior, for example, by tracking a user's path through a web site or network of sites, and compiling a profile based at least in part on pages or advertisements ultimately delivered. A correlation may be identified, such as for user purchases, for example. An identified correlation may be used to target potential purchasers by targeting content or advertisements to particular users.

Ad Serving

An “ad server” comprises a server that stores online advertisements for presentation to users. “Ad serving” refers to methods used to place online advertisements on websites, in applications, or other places where users are_more likely to see them, such as during an online session or during computing platform use, for example.

Ad Analytics

During presentation of advertisements, a presentation system may collect descriptive content about types of advertisements presented to users. A broad range of descriptive content may be gathered, including content specific to an advertising presentation system. Advertising analytics gathered may be transmitted to locations remote to an advertising presentation system for storage or for further evaluation. Where advertising analytics transmittal is not immediately available, gathered advertising analytics may be stored by an advertising presentation system until transmittal of those advertising analytics becomes available.

### Example Embodiments

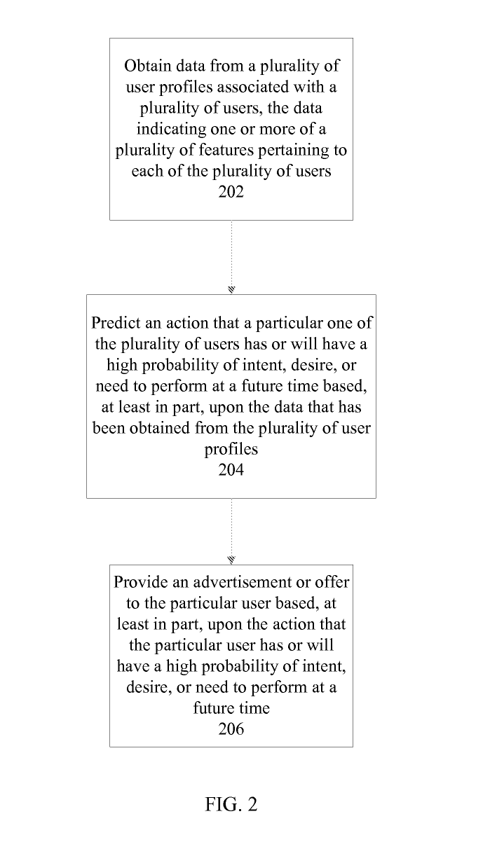

FIG. 2 is a process flow diagram illustrating an example method of providing an offer or advertisement to a particular user in accordance with various embodiments. The system may obtain data from a plurality of user profiles associated with a plurality of users at 202, where the data indicates one or more of a plurality of features pertaining to each of the plurality of users. The data may be obtained at a single point in time, or at multiple points in time. Therefore, the data may indicate a change or progression of at least one of the plurality of features pertaining to at least a portion of the plurality of users over time. For example, the data may indicate that the users who live in an extremely urban neighborhood tend to move to a more rural neighborhood over time.

The features that are obtained may include features that are changeable over time. Example features may include at least one of an age of the user, an area code, a zip code, a work address, a home address, a neighborhood urbanization level, a marital status, number of children, an age of one or more children, a purchase history with respect to one or more products or type of products, a purchase history with respect to one or more services or types of services, and/or one or more interests. A neighborhood urbanization level may indicate a level of urbanization of an area in which the user resides (e.g., in which the home address is located). For example, the urbanization level may indicate a degree to which a neighborhood is urbanized (vs. rural). The urbanization level may be designated by a numerical value in a range of values (e.g., between 1 and 10).

The features that are obtained may also include features that do not change over time. For example, the features may indicate a sex of the user, the birthplace of the user, and/or the number of siblings of the user.

The system may identify at 204 an action that a particular one of the plurality of users is predicted to (e.g., has or will have a high probability of intent, desire, or need to) perform at a future time based, at least in part, upon the data that has been obtained from the plurality of user profiles. For example, the action may include travel to a particular location, taking a vacation, or purchase of a particular item or service. The “future time” may be a particular time or time period, or may be an undesignated time in the future.

In accordance with various embodiments, a particular action (or set of actions) may be correlated with particular profile feature(s) based, at least in part, upon the data that has been obtained. More particularly, the system may identify a correlation between a set of one or more of the plurality of features and a tendency to perform a particular action or set of actions. The system may further calculate a probability that an individual with the set of features will perform the particular action or set of actions. Thus, the correlation may be represented as a one-to-one mapping or a numerical value indicating a probability that an individual with the set of features will perform the particular action or set of actions. For example, the system may ascertain that those individuals who take a vacation during March tend to be married and have at least one child (or vice versa). Thus, in this example, it may be desirable to identify those users who are likely to be married and have at least one child at a future time (designated future time or time period, or undesignated time in the future) for purposes of advertising vacations to those users.

In addition, the system may identify a change or progression of at least one of the plurality of features pertaining to at least a portion of the plurality of users over time based, at least in part, upon the data that has been obtained from the plurality of user profiles. The system may identify a correlation between the change or progression of the at least one of the plurality of features and an intent, desire, or need to perform an action or set of actions. The system may further calculate a probability that an individual for whom the change or progression with respect to the feature(s) is detected will perform the particular action or set of actions. Thus, the correlation may be represented as a one-to-one mapping or a numerical value indicating a probability that an individual for whom the change or progression with respect to the feature(s) is detected will perform the particular action or set of actions. For example, the system may ascertain that as single individuals get married, they tend to purchase a house and larger household items such as furniture.

The system may further apply a detected change or progression of at least one of the plurality of features pertaining to at least a portion of the plurality of users to predict a similar change or progression in other user(s). More particularly, the system may calculate a probability that, for a given individual, a particular set of one or more feature(s) will change or progress in the manner detected. For example, the system may detect that a subset of the plurality of users have had at least one child within one year of updating their status to married. As a result, the system may predict that other users in the plurality of users who recently changed their status to married will have at least one child within one year. Thus, the system may generate a predicted user profile for the particular user (and possibly each of the plurality of users), wherein the predicted user profile is predicted to include a plurality of features at a future time based, at least in part, upon the obtained data, the detected change or progression with respect to other users in the plurality of users, and/or the predicted user profiles of other users in the plurality of users. The predicted user profile may further indicate a probability with respect to each of the plurality of features, thereby indicating a probability that the prediction with respect to that feature is accurate.

Based upon the predicted user profile(s), the system may ascertain predicted feature(s) and/or predicted change/progression of at least one of the plurality of features of the particular user. For example, the system may ascertain that the user is likely to have at least one child at a future time. The system may further apply previously identified correlations between actions and feature(s) and/or previously identified correlations between actions and change/progression of at least one of the plurality of features to identify those actions that the user is likely to perform at a future time. For example, the system may conclude that since the user is married and is likely to have at least one child within the next year, the user is likely to take a vacation during March at a future time.

The plurality of users for which data is obtained may have one or more commonalties. More particularly, the plurality of users may share one or more attributes. As one example, the plurality of users may all be males within the 30-40 age range. As another example, the plurality of users may comprise contacts and/or friends of the particular user with respect to one or more social networks. As yet another example, at least one of the plurality of features of data (e.g., zip code) that has been collected may be common to the plurality of users.

The system may provide an advertisement or offer to the particular user at 206 based, at least in part, upon the action that the particular user is predicted to (e.g., has or will have a high probability of intent, desire, or need to) perform at a future time. More particularly, the advertisement or offer may pertain to the action. For example, an advertisement for a Hilton resort in Hawaii may pertain to taking a vacation. In addition, an offer may indicate an advantage to accepting the offer. For example, the advantage to accepting the offer may include a guaranteed price, a reduced price, a free item or service, or a coupon. The offer may further indicate that the offer is valid until a specified deadline or within a specified time period, wherein the specified deadline or specified time period is prior to the future time.

In accordance with various embodiments, the system may ascertain the future time at which the particular user is predicted to have a high probability of intent, desire, or need to perform the action. The system may then identify an optimal time at which the advertisement or offer is to be provided.

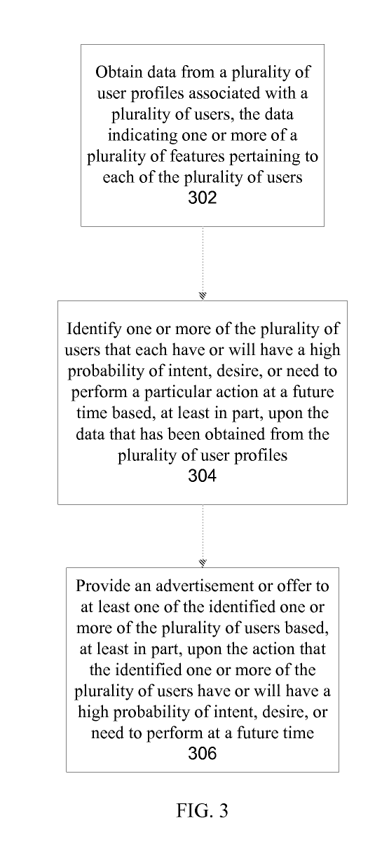

FIG. 3 is a process flow diagram illustrating an example method of providing offer(s) or advertisement(s) to one or more users in accordance with various embodiments. The system may obtain data from a plurality of user profiles associated with a plurality of users at 302, where the data indicates one or more of a plurality of features pertaining to each of the plurality of users. The data may be obtained at a single point in time, or at multiple points in time. Therefore, the data may indicate a change or progression of at least one of the plurality of features pertaining to at least a portion of the plurality of users over time. For example, the data may indicate that the users who are single at the age of 44 tend to remain single later in life. As another example, the data may indicate that the users who are married and younger than 25 tend to have multiple children by the age of 30.

The features that are obtained may include features that are changeable over time. Example features may include at least one of an age of the user, an area code, a zip code, a work address, a home address, a neighborhood urbanization level, a marital status, number of children, an age of one or more children, a purchase history with respect to one or more products or type of products, a purchase history with respect to one or more services or types of services, or one or more interests. A neighborhood urbanization level may indicate a level of urbanization of an area in which the user resides (e.g., in which the home address is located). For example, the urbanization level may indicate a degree to which a neighborhood is urbanized (vs rural). The urbanization level may be designated by a numerical value in a range of values (e.g., between 1 and 10).

The features that are obtained may also include features that do not change over time. For example, the features may indicate a sex of the user, the birthplace of the user, and/or the number of siblings of the user.

At 304, the system may identify one or more of the plurality of users that each are predicted to (e.g., have or will have a high probability of intent, desire, or need to) perform a particular action at a future time based, at least in part, upon the data that has been obtained from the plurality of user profiles. For example, the action may include travel to a particular location, taking a vacation, or purchase of a particular item or service. The “future time” may be a particular time or time period, or may be an undesignated time in the future.

In accordance with various embodiments, the particular action may be correlated with particular profile feature(s) based, at least in part, upon the data that has been obtained. More particularly, the system may identify a correlation between a set of one or more of the plurality of features and a tendency to perform the particular action. The system may further calculate a probability that an individual with the set of features will perform the particular action or set of actions. Thus, the correlation may be represented as a one-to-one mapping or a numerical value indicating a probability that an individual with the set of features will perform the particular action or set of actions. For example, the system may ascertain that those individuals who take a vacation during March tend to have at least one child. Thus, in this example, it may be desirable to identify those users who are likely to have at least one child at a future time (designated future time or time period, or undesignated time in the future), thereby identifying users who are likely to take a vacation during March.

In addition, the system may identify a change or progression of at least one of the plurality of features pertaining to at least a portion of the plurality of users over time based, at least in part, upon the data that has been obtained from the plurality of user profiles. The system may identify a correlation between the change or progression of the at least one of the plurality of features and an intent, desire, or need to perform the particular action. The system may further calculate a probability that an individual for whom the change or progression with respect to the feature(s) is detected will perform the particular action or set of actions. Thus, the correlation may be represented as a one-to-one mapping or a numerical value indicating a probability that an individual for whom the change or progression with respect to the feature(s) is detected will perform the particular action or set of actions. For example, the system may ascertain that as single individuals get married, they tend to purchase a house or larger household items such as furniture.

The system may further apply a detected change or progression of at least one of the plurality of features pertaining to at least a portion of the plurality of users to predict a similar change or progression in other users. More particularly, the system may calculate a probability that, for a given individual, a particular set of one or more feature(s) will change or progress in the manner detected. Thus, the system may generate a predicted user profile for each of the plurality of users, wherein the predicted user profile is predicted to include a plurality of features at a future time based, at least in part, upon the obtained data, the detected change or progression of other users in the plurality of users, and/or the predicted user profiles of other users in the plurality of users. The predicted user profile may further indicate a probability with respect to each of the plurality of features, thereby indicating a probability that the prediction with respect to that feature is accurate.

Based upon the predicted user profiles, the system may ascertain predicted feature(s) and/or predicted change/progression of at least one of the plurality of features of at least a portion of the plurality of users. For example, the system may identify those users who are likely to have at least one child at a future time. Therefore, the system may apply previously identified correlations between actions and feature(s) and/or previously identified correlations between actions and change/progression of at least one of the plurality of features to identify those users that are likely to perform the particular action at a future time.

The plurality of users may have one or more commonalties. More particularly, the plurality of users may share one or more attributes. As one example, the plurality of users may all be males within the 30-40 age range. As another example, the plurality of users may comprise contacts and/or friends of the particular user with respect to one or more social networks. As yet another example, at least one of the plurality of features of data that has been collected may be common to the plurality of users.

The system may provide an advertisement or offer at 306 to at least one of the identified one or more of the plurality of users based, at least in part, upon the action that the identified one or more of the plurality of users are predicted to (e.g., have or will have a high probability of intent, desire, or need to) perform at a future time. More particularly, the advertisement or offer may pertain to the action. In addition, an offer may indicate an advantage to accepting the offer. For example, the advantage to accepting the offer may include a guaranteed price, a reduced price, a free item or service, or a coupon. The offer may further indicate that the offer is valid until a specified deadline or within a specified time period, wherein the specified deadline or specified time period is prior to the future time.

In accordance with various embodiments, the system may ascertain the future time at which the identified user(s) are predicted to have a high probability of intent, desire, or need to perform the particular action. The system may then identify an optimal time at which the advertisement or offer is to be provided.

The price that an advertiser or application developer/owner is charged for providing an offer or advertisement may be based upon one or more factors. More particularly, the price may be based, at least in part, upon the probability that a user receiving the offer or advertisement is likely to perform an action pertaining to the offer or advertisement. In accordance with various embodiments, the price may be higher if the user has a high probability of performing an action pertaining to the offer or advertisement, and lower if the user has a low probability of performing an action pertaining to the offer or advertisement. For example, if a user is predicted to take a vacation within the next 6 months, the price for providing an offer or advertisement pertaining to vacation packages to the user may be higher than if the user is not predicted to take a vacation within the next 6 months. Similarly, the price may be higher if the user is predicted to have a particular set of features correlated with the action pertaining to the offer or advertisement, and lower if the user is not predicted to have the particular set of features correlated with the action pertaining to the offer or advertisement.

In accordance with various embodiments, a user may opt-in to the system. More particularly, as a result of opting-in, the system may track the location of the user and/or other features pertaining to the user, enabling the user to receive applications or advertisements. The user may receive various benefits as a result of opting in. For example, the user may receive monetary payment, discounts, or other services in return for the user opting in to the system.

The system may determine whether a user ultimately possesses predicted feature(s) and/or performs predicted action(s) at a future time, as previously predicted by the system. This determination may be used to further refine the predictions performed by the system. More particularly, by confirming predicted feature(s) and/or action(s), the system may determine which feature(s) and/or correlation(s) are most likely to result in accurate predictions (e.g., by associating a weight with the feature(s) or correlation(s) from which the action was predicted).

The disclosed embodiments support the generation of predicted user profiles and/or the prediction of actions that users are likely to take in the future. From this information, advertisers and/or offers may be strategically provided at an optimum time with respect to the predicted profiles and/or predicted actions. For example, the system may ascertain that a user is interested in Toyota vehicles and that the user is predicted to shop for a car in December before the new car models are released in January. Therefore, the system may provide an advertisement for a Toyota Prius to the user in November.

Network

A network may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, or any combination thereof. Likewise, sub-networks, such as may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

Content Distribution Network

A distributed system may include a content distribution network. A “content delivery network” or “content distribution network” (CDN) generally refers to a distributed content delivery system that comprises a collection of computers or computing devices linked by a network or networks. A CDN may employ software, systems, protocols or techniques to facilitate various services, such as storage, caching, communication of content, or streaming media or applications. Services may also make use of ancillary technologies including, but not limited to, “cloud computing,” distributed storage, DNS request handling, provisioning, signal monitoring and reporting, content targeting, personalization, or business intelligence. A CDN may also enable an entity to operate or manage another's site infrastructure, in whole or in part.

Peer-to-Peer Network

A peer-to-peer (or P2P) network may employ computing power or bandwidth of network participants in contrast with a network that may employ dedicated devices, such as dedicated servers, for example; however, some networks may employ both as well as other approaches. A P2P network may typically be used for coupling nodes via an ad hoc arrangement or configuration. A peer-to-peer network may employ some nodes capable of operating as both a “client” and a “server.”

Wireless Network

A wireless network may couple client devices with a network. A wireless network may employ stand-alone ad-hoc networks, mesh networks, Wireless LAN (WLAN) networks, cellular networks, or the like.

A wireless network may further include a system of terminals, gateways, routers, or the like coupled by wireless radio links, or the like, which may move freely, randomly or organize themselves arbitrarily, such that network topology may change, at times even rapidly. A wireless network may further employ a plurality of network access technologies, including Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example.

For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like.

Internet Protocol

Signal packets communicated via a network, such as a network of participating digital communication networks, may be compatible with or compliant with one or more protocols. Signaling formats or protocols employed may include, for example, TCP/IP, UDP, DECnet, NetBEUI, IPX, Appletalk, or the like. Versions of the Internet Protocol (IP) may include IPv4 or IPv6.

The Internet refers to a decentralized global network of networks. The Internet includes LANs, WANs, wireless networks, or long haul public networks that, for example, allow signal packets to be communicated between LANs. Signal packets may be communicated between nodes of a network, such as, for example, to one or more sites employing a local network address. A signal packet may, for example, be communicated over the Internet from a user site via an access node coupled to the Internet. Likewise, a signal packet may be forwarded via network nodes to a target site coupled to the network via a network access node, for example. A signal packet communicated via the Internet may, for example, be routed via a path of gateways, servers, etc. that may route the signal packet in accordance with a target address and availability of a network path to the target address.

### Network Architecture

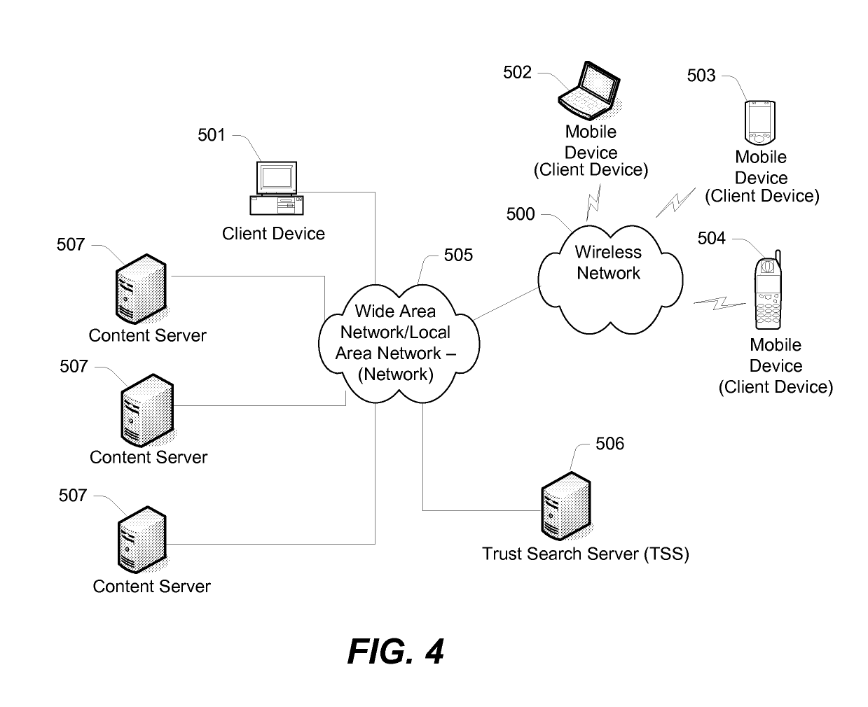

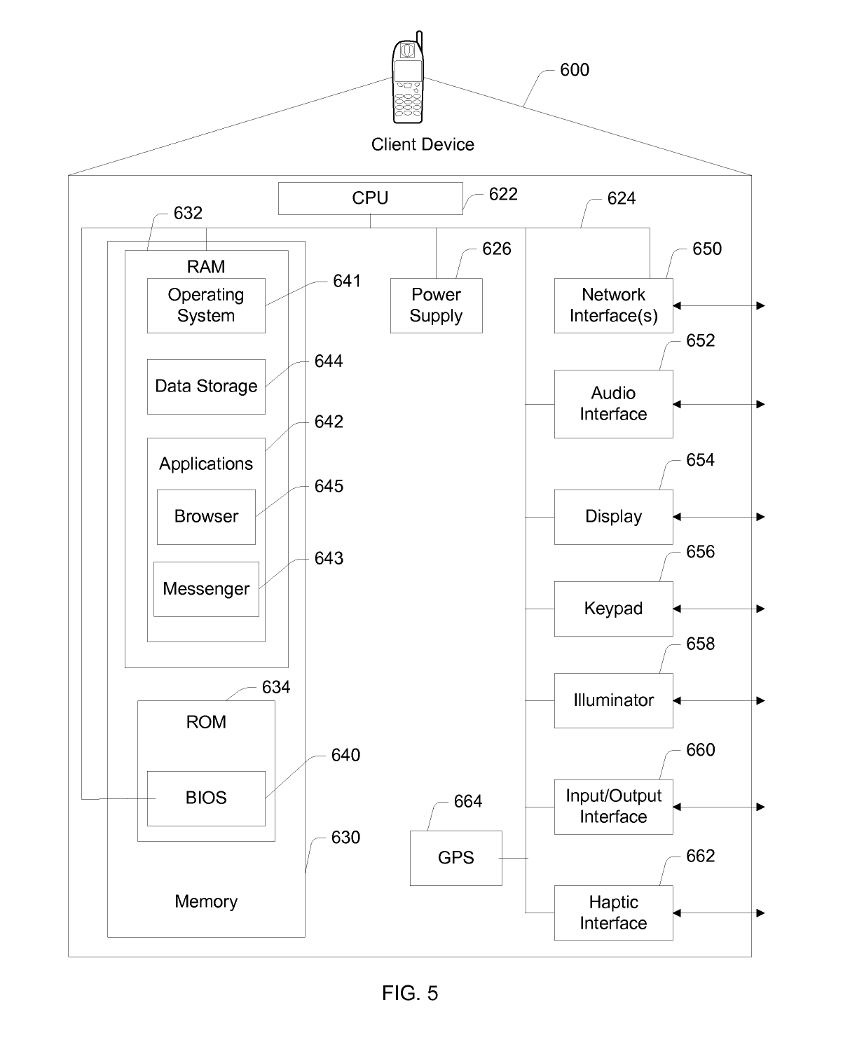

The disclosed embodiments may be implemented in any of a wide variety of computing contexts. FIG. 4 is a schematic diagram illustrating an example embodiment of a network. Other embodiments that may vary, for example, in terms of arrangement or in terms of type of components, are also intended to be included within claimed subject matter. Implementations are contemplated in which users interact with a diverse network environment. As shown, FIG. 5, for example, includes a variety of networks, such as a LAN/WAN 505 and wireless network 500, a variety of devices, such as client devices 501-504, and a variety of servers such as content server(s) 507 and search server 506. The servers may also include an ad server (not shown). As shown in this example, the client devices 501-504 may include one or more mobile devices 502, 503, 504. Client device(s) 501-504 may be implemented, for example, via any type of computer (e.g., desktop, laptop, tablet, etc.), media computing platforms (e.g., cable and satellite set top boxes), handheld computing devices (e.g., PDAs), cell phones, or any other type of computing or communication platform.

User locations may be identified and implemented to facilitate location-based application pop-ups according to the disclosed embodiments in some centralized manner. This is represented in FIG. 4 by content server(s) 507, which may correspond to multiple distributed devices and data store(s). The content server(s) 507 and/or corresponding data store(s) may store user account data, user locations, advertisements and/or offers, etc.

Server

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

Content Server

A content server may comprise a device that includes a configuration to provide content via a network to another device. A content server may, for example, host a site, such as a social networking site, examples of which may include, without limitation, Flicker, Twitter, Facebook, LinkedIn, or a personal user site (such as a blog, vlog, online dating site, etc.). A content server may also host a variety of other sites, including, but not limited to business sites, educational sites, dictionary sites, encyclopedia sites, wikis, financial sites, government sites, etc.

A content server may further provide a variety of services that include, but are not limited to, web services, third-party services, audio services, video services, email services, instant messaging (IM) services, SMS services, MMS services, FTP services, voice over IP (VOIP) services, calendaring services, photo services, or the like. Examples of content may include text, images, audio, video, or the like, which may be processed in the form of physical signals, such as electrical signals, for example, or may be stored in memory, as physical states, for example.

Examples of devices that may operate as a content server include desktop computers, multiprocessor systems, microprocessor-type or programmable consumer electronics, etc.

Client Device

FIG. 5 is a schematic diagram illustrating an example embodiment of a client device in which various embodiments may be implemented. A client device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device, a Personal Digital Assistant (PDA), a handheld computer, a tablet computer, a laptop computer, a set top box, a wearable computer, an integrated device combining various features, such as features of the forgoing devices, or the like.

As shown in this example, a client device 600 may include one or more central processing units (CPUs) 622, which may be coupled via connection 624 to a power supply 626 and a memory 630. The memory 630 may include random access memory (RAM) 632 and read only memory (ROM) 634. The ROM 634 may include a basic input/output system (BIOS) 640.

The RAM 632 may include an operating system 641. More particularly, a client device may include or may execute a variety of operating systems, including a personal computer operating system, such as a Windows, iOS or Linux, or a mobile operating system, such as iOS, Android, or Windows Mobile, or the like. The client device 600 may also include or may execute a variety of possible applications 642 (shown in RAM 632), such as a client software application such as messenger 643, enabling communication with other devices, such as communicating one or more messages, such as via email, short message service (SMS), or multimedia message service (MMS), including via a network, such as a social network, including, for example, Facebook, LinkedIn, Twitter, Flickr, or Google, to provide only a few possible examples. The client device 600 may also include or execute an application to communicate content, such as, for example, textual content, multimedia content, or the like, which may be stored in data storage 644. A client device may also include or execute an application such as a browser 645 to perform a variety of possible tasks, such as browsing, searching, playing various forms of content, including locally stored or streamed video, or games (such as fantasy sports leagues).

The client device 600 may send or receive signals via one or more interface(s). As shown in this example, the client device 600 may include one or more network interfaces 650. The client device 600 may include an audio interface 652. In addition, the client device 600 may include a display 654 and an illuminator 658. The client device 600 may further include an Input/Output interface 660, as well as a Haptic Interface 662 supporting tactile feedback technology.

The client device 600 may vary in terms of capabilities or features. Claimed subject matter is intended to cover a wide range of potential variations. For example, a cell phone may include a keypad such 656 such as a numeric keypad or a display of limited functionality, such as a monochrome liquid crystal display (LCD) for displaying text. In contrast, however, as another example, a web-enabled client device may include one or more physical or virtual keyboards, mass storage, one or more accelerometers, one or more gyroscopes, global positioning system (GPS) 664 or other location identifying type capability, or a display with a high degree of functionality, such as a touch-sensitive color 2D or 3D display, for example. The foregoing is provided to illustrate that claimed subject matter is intended to include a wide range of possible features or capabilities.

According to various embodiments, input may be obtained using a wide variety of techniques. For example, input for downloading or launching an application may be obtained via a graphical user interface from a user's interaction with a local application such as a mobile application on a mobile device, web site or web-based application or service and may be accomplished using any of a variety of well-known mechanisms for obtaining information from a user. However, it should be understood that such methods of obtaining input from a user are merely examples and that input may be obtained in many other ways.

Regardless of the system's configuration, it may employ one or more memories or memory modules configured to store data, program instructions for the general-purpose processing operations and/or the inventive techniques described herein. The program instructions may control the operation of an operating system and/or one or more applications, for example. The memory or memories may also be configured to store instructions for performing the disclosed methods, graphical user interfaces to be displayed in association with the disclosed methods, etc.

Because such information and program instructions may be employed to implement the systems/methods described herein, the disclosed embodiments relate to machine readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as ROM and RAM. Examples of program instructions include both machine code, such as produced by a compiler, and files containing higher level code that may be executed by the computer using an interpreter.

Computer program instructions with which various embodiments are implemented may be stored in any type of computer-readable media, and may be executed according to a variety of computing models including a client/server model, a peer-to-peer model, on a stand-alone computing device, or according to a distributed computing model in which various of the functionalities described herein may be effected or employed at different locations.

The disclosed techniques may be implemented in any suitable combination of software, hardware, and/or firmware, such as a web-based server or desktop computer system. Moreover, a system implementing various embodiments may be a portable device, such as a laptop or cell phone. The apparatus and/or web browser may be specially constructed for the required purposes, or it may be a general-purpose computer selectively activated or reconfigured by a computer program and/or data structure stored in the computer. The processes presented herein are not inherently related to any particular computer or other apparatus. In particular, various general-purpose machines may be used with programs written in accordance with the teachings herein, or it may be more convenient to construct a more specialized apparatus to perform the disclosed method steps.

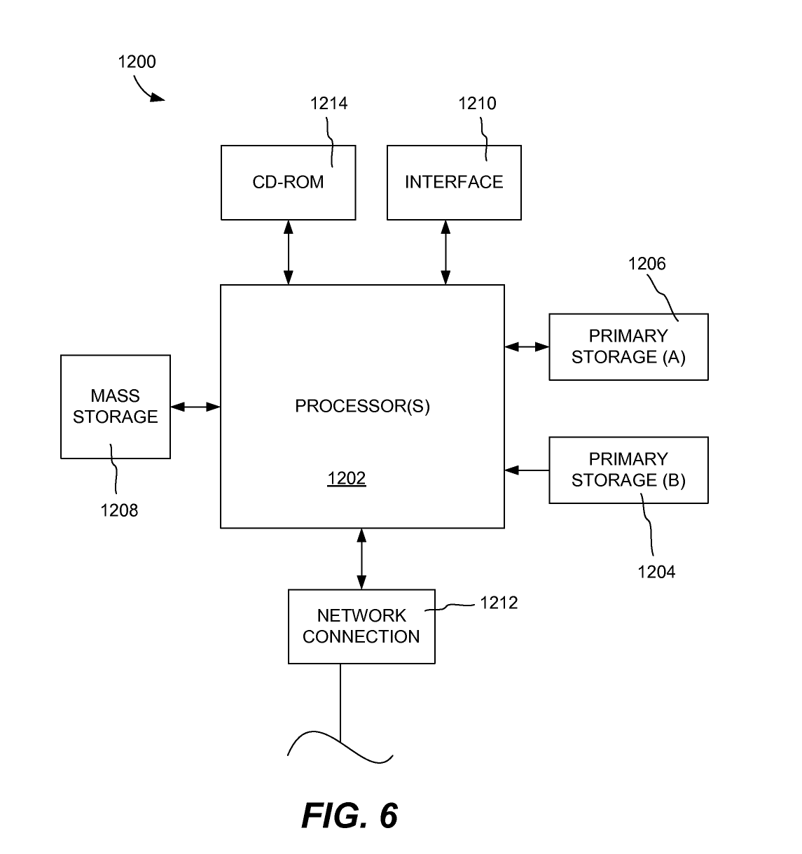

FIG. 6 illustrates a typical computer system that, when appropriately configured or designed, can serve as a system in accordance with various embodiments. The computer system 1200 includes any number of CPUs 1202 that are coupled to storage devices including primary storage 1206 (typically a RAM), primary storage 1204 (typically a ROM). CPU 1202 may be of various types including microcontrollers and microprocessors such as programmable devices (e.g., CPLDs and FPGAs) and unprogrammable devices such as gate array ASICs or general purpose microprocessors. As is well known in the art, primary storage 1204 acts to transfer data and instructions uni-directionally to the CPU and primary storage 1206 is used typically to transfer data and instructions in a bi-directional manner. Both of these primary storage devices may include any suitable computer-readable media such as those described above. A mass storage device 1208 is also coupled bi-directionally to CPU 1202 and provides additional data storage capacity and may include any of the computer-readable media described above. Mass storage device 1208 may be used to store programs, data and the like and is typically a secondary storage medium such as a hard disk. It will be appreciated that the information retained within the mass storage device 1208, may, in appropriate cases, be incorporated in standard fashion as part of primary storage 1206 as virtual memory. A specific mass storage device such as a CD-ROM 1214 may also pass data uni-directionally to the CPU.

CPU 1202 may also be coupled to an interface 1210 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 1202 optionally may be coupled to an external device such as a database or a computer or telecommunications network using an external connection as shown generally at 1212. With such a connection, it is contemplated that the CPU might receive information from the network, or might output information to the network in the course of performing the method steps described herein.

Although the foregoing embodiments have been described in some detail for purposes of clarity of understanding, it will be apparent that certain changes and modifications may be practiced within the scope of the appended claims. Therefore, the present embodiments are to be considered as illustrative and not restrictive and are not to be limited to the details given herein, but may be modified within the scope and equivalents of the appended claims.

What is claimed is:

1. A method, comprising:
obtaining data from a plurality of user profiles associated with a plurality of users, the data indicating one or more of a plurality of features pertaining to each of the plurality of users;
predicting an action that a particular one of the plurality of users has or will have a high probability of intent, desire, or need to perform at a future time based, at least in part, upon the data that has been obtained from the plurality of user profiles; and
providing an advertisement or offer to the particular user based, at least in part, upon the action that the particular user has or will have a high probability of intent, desire, or need to perform at a future time.

2. The method as recited in claim 1, wherein obtaining data from the plurality of profiles comprises:
detecting a change or progression of at least one of the plurality of features pertaining to at least a portion of the plurality of users over time based, at least in part, upon the data that has been obtained from the plurality of profiles; and
generating a predicted user profile for the particular user based, at least in part, upon the detected change or progression.

3. The method as recited in claim 1, further comprising:
generating a predicted user profile for the particular user, wherein the predicted user profile is predicted to include a plurality of features at the future time based, at least in part, upon the obtained data;
wherein predicting an action is performed based, at least in part, upon the predicted user profile.

4. The method as recited in claim 1, further comprising:
generating a predicted user profile for each of the plurality of users, wherein each predicted user profile is predicted to include a plurality of features at the future time based, at least in part, upon the obtained data;
wherein predicting an action is performed based, at least in part, upon the predicted user profile for at least a portion of the plurality of users.

5. The method as recited in claim 1, wherein the plurality of users comprise contacts of the particular user or friends of the particular user with respect to one or more social networks.

6. The method as recited in claim 1, wherein at least one of the plurality of features is common to the plurality of users.

7. A method, comprising:
obtaining data from a plurality of user profiles associated with a plurality of users, the data indicating one or more of a plurality of features pertaining to each of the plurality of users;
identifying one or more of the plurality of users that each have or will have a high probability of intent, desire, or need to perform a particular action at a future time based, at least in part, upon the data that has been obtained from the plurality of user profiles; and
providing an advertisement or offer to the at least one of the identified one or more of the plurality of users based, at least in part, upon the action that the identified one or more of the plurality of users have or will have a high probability of intent, desire, or need to perform at a future time.

8. The method as recited in claim 7, wherein the action comprises travel to a particular location, taking a vacation, or purchase of a particular item or service.

9. The method as recited in claim 7, further comprising:
identifying a change or progression of at least one of the plurality of features pertaining to at least a portion of the plurality of users over time based, at least in part, upon the data that has been obtained from the plurality of user profiles; and
identifying a correlation between the change or progression of the at least one of the plurality of features and an intent, desire, or need to perform the particular action.

10. The method as recited in claim 7, wherein identifying one or more of the plurality of users that each have or will have a high probability of intent, desire, or need to perform a particular action at a future time based, at least in part, upon the data that has been obtained from the plurality of user profiles comprises:
identifying a correlation between a set of one or more of the plurality of features and an intent, desire, or need to perform the particular action.

11. A non-transitory computer-readable medium storing thereon computer-readable instructions, comprising;
instructions for obtaining data from a plurality of user profiles associated with a plurality of users, the data indicating one or more of a plurality of features pertaining to each of the plurality of users;
instructions for predicting an action that a particular one of the plurality of users has or will have a high probability of intent, desire, or need to perform at a future time based, at least in part, upon the data that has been obtained from the plurality of user profiles; and
instructions for providing an advertisement or offer to the particular user based, at least in part, upon the action that the particular user has or will have a high probability of intent, desire, or need to perform at a future time.

12. The non-transitory computer-readable medium as recited in claim 11, wherein the action comprises travel to a particular location, taking a vacation, or purchase of a particular item or service.

13. The non-transitory computer-readable medium as recited in claim 11, wherein providing an advertisement or offer comprises:
providing an advertisement pertaining to the action to the particular user.

14. The non-transitory computer-readable medium as recited in claim 11, wherein providing an advertisement or offer comprises:
providing an offer to the particular user, the offer pertaining to the action and indicating an advantage to accepting the offer, wherein the offer is valid until a specified deadline or within a specified time period, wherein the specified deadline or specified time period is prior to the future time.

15. The non-transitory computer-readable medium as recited in claim 14, wherein the advantage to accepting comprises a guaranteed price, a reduced price, a free item or service, or a coupon.

16. The non-transitory computer-readable medium as recited in claim 11, wherein the one or more of the plurality of features comprise at least one of an age, an area code, a zip code, a work address, a home address, a neighborhood urbanization level, a marital status, number of children, age of one or more children, a purchase history with respect to one or more products or type of products, a purchase history with respect to one or more services or types of services, or an interest.

17. An apparatus, comprising:
a processor; and
a memory, at least one of the processor or the memory being adapted for:
obtaining data from a plurality of user profiles associated with a plurality of users, the data indicating one or more of a plurality of features pertaining to each of the plurality of users;
identifying one or more of the plurality of users that each have or will have a high probability of intent, desire, or need to perform a particular action at a future time based, at least in part, upon the data that has been obtained from the plurality of user profiles; and
providing an advertisement or offer to at least one of the identified one or more of the plurality of users based, at least in part, upon the action that the identified one or more of the plurality of users have or will have a high probability of intent, desire, or need to perform at a future time.

18. The apparatus as recited in claim 17, wherein providing an advertisement or offer comprises:
providing an offer to the at least one of the identified one or more of the plurality of users, the offer pertaining to the action and indicating an advantage to accepting the offer, wherein the offer is valid until a specified deadline or within a specified time period, wherein the specified deadline or specified time period is prior to the future time.

19. The apparatus as recited in claim 18, wherein the advantage to accepting comprises a guaranteed price, a reduced price, a free item or service, or a coupon.

20. The apparatus as recited in claim 17, wherein the plurality of users are related as friends or contacts within or among one or more social networks.

21. The apparatus as recited in claim 17, wherein one or more attributes are common to the plurality of users.

22. The apparatus as recited in claim 17, at least one of the processor or the memory being further adapted for performing steps, comprising:
identifying the future time at which the one or more of the plurality of users will have a high probability of intent, desire, or need to perform the particular action;
identifying an optimal time at which the advertisement or offer is to be provided;
wherein providing the advertisement or offer is performed according to the optimal time.
